(19) United States
(12) Patent Application Publication
(10) Pub. No.: US 2002/0182577 A1
(43) Pub. Date: Dec. 5, 2002

(54) Question reproducible exercise book and question reproducible system

(76) Inventor: Hiroaki Yoshizawa, Chiba (JP)

Correspondence Address: POLSTER, LIEDER, WOODRUFF & LUCCHESI, L.C., 763 SOUTH NEW BALLAS RD., ST. LOUIS, MO, 63141, US

(21) Appl. No.: 10/137,261

(22) Filed: May 2, 2002

(30) Foreign Application Priority Data
May 7, 2001 (JP) PATENT2001-136748

(51) Int. Cl. G09B 3/00; G09B 7/00

(52) U.S. Cl. 434/322

(57) ABSTRACT

A question reproducible exercise book for reproducing questions which are set in examinations held periodically and provided in the form of being answered by choosing an appropriate alternative among a plurality of alternatives with respect to the question sentence or a non-relevant in the event of not finding the appropriate alternative, in which overlapping questions specifying information including at least numbers of questions and alternatives appeared in a particular examination and overlapping in examinations held earlier and later than the above-mentioned examination is indicated instead of omitting one or both of a portion of questions and alternatives overlapping in examinations held earlier and later than a particular examination and a portion of explanations with respect to the overlapping questions and alternatives.

### BACKGROUND OF THE INVENTION

The present invention relates to a question reproducible exercise book for examinations including qualification tests such as a Building Lots and Buildings Transaction Business supervisor qualification test, an English proficiency test and the like held periodically once or twice a year at regular intervals, and more particularly to a question reproducible exercise book composed as to answer the questions selectively by making a choice among a plurality of alternatives or by choosing a non-relevant.

For example, in the qualification tests such as a Building Lots and Buildings Transaction Business supervisor qualification test, an English proficiency test and the like held periodically once or twice a year at regular intervals, questions are answered in the form of choosing an appropriate alternative with respect to a question sentence or a non-relevant in the event of not finding the appropriate alternative among a plurality of alternatives formed of short sentences listed in parallel. The above-mentioned examinations are generally called selective or alternative type examination, in which contents are highly specialized mostly and the questions tend to be narrowed down to a certain range. Thus, questions and alternatives which have ever been set in earlier examinations appear in later examinations without changes or with minor changes in order. Further, alternatives which have ever been set in the earlier examinations are set in the later examinations by being mixed with other alternatives.

In order to score high on the above-mentioned examinations, it is necessary to grasp tendencies of the questions and study the questions which have ever been set in the earlier examinations repeatedly and effectively.

On the other hand, questions causing errors and alternatives selected by mistake in the examinations are considered as weak points of a learner. Accordingly, the learner has to study the weak points intensively.

Therefore, not a few exercise books for examinees to review the questions set in the earlier examinations are published. As an example of the above-mentioned question reproducible exercise book, a year-by-year question reproducible exercise book as shown is FIGS. 17 and 18. The year-by-year question reproducible exercise book is edited by compiling the questions set in the earlier examinations on a year-by-year basis. In the year-by-year question reproducible exercise book, a paragraph 175 comprising year when a particular examination is held 173, numbers of questions 177 and alternatives 178 with respect to the questions 176 is provided in a question reproducible portion 170 in similar order to a real examination. In an answer reproducible portion 180, year when the examination is held 183, numbers of answers 187, conclusions 189 and results whether correct or incorrect 188 of the alternatives accompanied by brief explanations 186 on which the results are based are provided. The above-mentioned year-by-year question reproducible exercise book is composed straight from a real examination and enables the examinees to study with a sense of realism.

On the other hand, as another example of the question reproducible exercise book, there is an exercise book edited with contents classified by categories as shown in FIG. 19. As for a question reproducible exercise book with category classification 190, questions set in the earlier examinations are classified by several categories and listed in year-by-year order in a page of a question reproducible portion. A method of reproducing each of the questions and answers in the question reproducible exercise book with category classification is similar to the above-mentioned year-by-year question reproducible exercise book. Accordingly, the question reproducible exercise book with category classification is effective in learning sequentially by categories or subjects, which provides the learners with convenience and effective leaning.

However, in a conventional question reproducible exercise book, questions and alternatives set in earlier examinations are compiled and reproduced straight from the real examinations. Therefore, in learning questions set in the earlier examinations with the conventional question reproducible exercise book, learners have to answer overlapping questions and choose overlapping alternatives set in the earlier examinations repeatedly, thereby spending time for learning similar questions over again. Thus learners with high ability feel wasting time.

On the other hand, the questions and the alternatives set repeatedly in the earlier examinations are more likely to be important. Accordingly, the learners as well as the same with high abilities need to learn the questions and the alternatives intensively.

However, information whether the question or the alternative appeared in an examination at a particular year for the first time or the question or the alternative has ever been set in the earlier examinations is not indicated in the conventional question reproducible exercise book.

Further, although the most effective way for a learner who has acquired general knowledge to learn is to repeat learning the questions and the alternatives which were answered incorrectly at least once in the past, that is to narrow down the learner's weak points, the conventional exercise books are incapable of responding to the learner's request. And there have been no other way but to put marks on the questions and alternatives which were previously answered incorrectly and to repeat learning the same.

### SUMMARY OF THE INVENTION

In view of the foregoing problems, it is an object of the present invention to provide a question reproducible exercise book by which learners with high ability can skip questions and alternatives overlapping in the earlier examinations when unnecessary in order to make effective use of time, in the event of preparing for examinations held periodically in the form of answering a question by choosing an appropriate alternative or a non-relevant among a plurality of alternatives.

Further, in the view of the foregoing provlems, it is another object of the present invention to provide a question reproducible exercise book by which the learners can easily discriminate questions and alternatives with high importance and grasp tendencies of the examinations accurately, in the event of preparing for examinations held periodically in the form of answering a question by choosing an appropriate alternative or a non-relevant among a plurality of alternatives.

Furthermore, it is still another object of the present invention to provide a question reproducible exercise book by which the learners can focus only on the questions and the alternatives answered incorrectly and narrow down the weak point by learning repeatedly, thereby taking extremely effective measures against the examinations, in the event of preparing for examinations held periodically in the form of answering a question by choosing an appropriate alternative or a non-relevant among a plurality of alternatives.

To solve the above-mentioned problems, the present invention claimed in claim 1 provides a question reproducible exercise book for preparing for examinations held periodically in the form of answering a question by choosing an appropriate alternative with respect to the question among a plurality of alternatives including a non-relevant in the event of not finding the appropriate alternative, in which overlapping questions specifying information including at least numbers of questions and alternatives appeared in a particular examination and overlapping in examinations held earlier and later than the above-mentioned examination is indicated instead of omitting one or both of a portion of questions and alternatives overlapping in examinations held earlier and later than the particular examination and a portion of explanations with respect to the overlapping questions and alternatives.

With the above-mentioned question reproducible exercise book, learners can omit answering questions or choosing alternatives overlapping in the earlier or later examinations if unnecessary, thereby saving time of learning. On the other hand, tendencies of questions in the examination can be accurately grasped by determining importance of the questions and alternatives which appeared frequently in the past.

The present invention claimed in claim 2 provides a question reproducible exercise book for preparing for examinations held periodically in the form of answering a question by choosing an appropriate alternative among a plurality of alternatives including a non-relevant in the event of not finding the appropriate alternative,

in which one or both of a portion of questions and alternatives overlapping in the examinations held earlier or later than a particular examination and a portion of explanations with respect to the overlapping questions and alternatives are indicated in a different color from other portions, and a transparent sheet having a color identical to the above-mentioned indicated portion accompanies thereto.

With the above-mentioned question reproducible exercise book, in the event of not finding necessity to repeat answering, the learners can easily omit the questions and alternatives overlapping in the earlier or later examinations because of the indicated color clearly different from other questions and alternatives, thereby saving time and effort easily. Additionally, using the transparent sheet in the color identical to the overlapping questions, the questions, the alternatives or the answers with respect to the questions can be made invisible for learners' convenience.

The present invention claimed in claim 3 provides a question reproducible system configured to play back a recording medium storing questions of examinations held periodically in the form of answering a question by choosing an appropriate alternative with respect to the question among a plurality of alternatives including a non-relevant in the event of not finding the appropriate alternative on computers and to display the above-mentioned contents on a display screen,

in which questions reproduced by year or by category are indicated on the above-mentioned display screen, and when a predetermined point in a menu on the screen is clicked, one or both of a display of overlapping questions and alternatives set in examinations held earlier or later than a particular examination and a display of explanations with respect to the overlapping questions and alternatives are erased, and overlapping questions specifying information including at least numbers of the questions and the alternatives overlapping in the particular examination as well as examinations held earlier or later than the examination is indicated instead.

The present invention claimed in claim 4 provides a question reproducible system configured to play back a recording medium storing questions of examinations held periodically in the form of answering a question by choosing a an appropriate alternative with respect to the question among a plurality of alternatives including a non-relevant in the event of not finding the appropriate alternative on computers and to display the above-mentioned contents on a display screen,

in which questions reproduced by year or by category are indicated on the above-mentioned display screen, and when a predetermined point in a menu on the screen is clicked, one or both of a portion of questions and alternatives overlapping in the examinations held earlier or later than a particular examination and a portion of explanations with respect to the overlapping questions and alternatives are indicated in a different color from other portions.

With the above-mentioned question reproducible system, learners can make use of the system not only in an ordinary exercise but also in an effective learning by omitting the indications of the questions and alternatives overlapping in the examinations held earlier or later than a particular examination when necessary. Further, tendencies of the questions set in the examination can be grasped accurately and easily because of the indication color of the overlapping questions and alternatives set in the examinations held earlier or later than the particular examination different from other portions.

The present invention claimed in claim 5 provides a question reproducible system configured to play back a recording medium storing examination questions which are set in the form of answering by choosing an appropriate alternative with respect to the question among a plurality of alternatives including a non-relevant in the event of not finding the appropriate alternative on computers and to display the above-mentioned contents on a display screen,

in which the above-mentioned examination questions are indicated on the above-mentioned display screen, and when a predetermined point in a menu is clicked after inputting an answer with respect to the above-mentioned question or a choice made with respect to the above-mentioned alternatives on the screen, portions of the question and alternatives answered incorrectly are indicated in a color different from other portions.

Further, the present invention claimed in claim 6 provides a question reproducible system configured to play back a recording medium storing examination questions which are set in the form of answering by choosing an appropriate alternative with respect to the question among a plurality of alternatives including a non-relevant

in the event of not finding the appropriate alternative on computers and to display the above-mentioned contents on a display screen,

in which the above-mentioned examination questions are indicated on the above-mentioned display screen, and when a predetermined point in a menu is clicked after an input of an answer with respect to the above-mentioned question or a choice made with respect to the above-mentioned alternatives on the screen, indications of the questions and the alternatives answered correctly are erased and only the questions and alternatives answered incorrectly are indicated.

With the above-mentioned question reproducible exercise book, a learner who has acquired general knowledge can learn questions answered incorrectly and alternatives chosen by mistake which are regarded as the learners' weak points easily and effectively by indicating only the questions and alternatives in a different color from other portions or by erasing other portions.

The present invention claimed in claim 7 provides a question reproducible system configured to play back a recording medium storing examination questions which are set in the form of answering by choosing an appropriate alternative with respect to the question among a plurality of alternatives including a non-relevant in the event of not finding the appropriate alternative on computers and to display the above-mentioned contents on a display screen,

in which the above-mentioned examination questions are indicated on the above-mentioned display screen, and when a predetermined point in a menu is clicked after input of an answer with respect to the above-mentioned question or a choice made with respect to the above-mentioned alternatives on the screen, indications of the questions and the alternatives answered correctly are erased and only the questions and alternatives answered incorrectly are indicated in the above-mentioned screen, and further when a predetermined point in a menu is clicked after input of answers with respect to the above-mentioned questions and alternatives answered incorrectly, only the questions and alternatives answered incorrectly again are indicated, and operations such as mentioned above can be repeated.

With the above-mentioned question reproducible system, the above-mentioned questions answered incorrectly and alternatives chosen by mistake which are regarded as the learners' weak point can be narrowed down by repeats of answering only the questions and alternatives previously answered incorrectly, thereby providing extremely effective learning.

### BRIEF DESCRIPTION OF THE DRAWINGS

FIG. 1 is a drawing for showing a question reproducible portion in a year-by-year question reproducible exercise book of a first example of the present invention,

FIG. 2 is a drawing for showing a portion of answers in the year-by-year question reproducible exercise book of the first example of the present invention,

FIG. 3 is a drawing for showing a category-by-category question reproducible exercise book of a second example of the present invention,

FIG. 4 is a drawing for showing a question reproducible portion in a year-by-year question reproducible exercise book printed in two colors of a third example of the present invention,

FIG. 5 is a drawing for showing a portion of answers in the year-by-year question reproducible exercise book printed in two colors of the third example of the present invention,

FIG. 6 is a drawing for showing a usage condition of the year-by-year question reproducible exercise book printed in two colors of the third example of the present invention,

FIG. 7 is a block diagram for illustrating a question reproducible system of a fourth example of the present invention,

FIG. 8 is an illustration a display screen for illustrating the question reproducible system of the fourth example of the present invention,

FIG. 9 is another illustration of the display screen for illustrating the question reproducible system of the fourth example of the present invention,

FIG. 10 is another illustration of the display screen for illustrating the question reproducible system of the fourth example of the present invention,

FIG. 11 is another illustration of the display screen for illustrating the question reproducible system of the fourth example of the present invention,

FIG. 12 is another illustration of the display screen for illustrating the question reproducible system of the fourth example of the present invention,

FIG. 13 is another illustration of the display screen for illustrating the question reproducible system of the fourth example of the present invention,

FIG. 14 is another illustration of the display screen for illustrating the question reproducible system of the fourth example of the present invention,

FIG. 15 is a drawing for showing an example of a fill-in-the-bland question,

FIG. 16 is a drawing for showing an example of a question in the form of answering by choosing and combining alternatives,

FIG. 17 is a drawing for showing an example of a conventional year-by-year question reproducible exercise book,

FIG. 18 is a drawing for showing another example of a conventional year-by-year question reproducible exercise book, and

FIG. 19 is a drawing for showing an example of a conventional category-by-category question reproducible exercise book.

### DETAILED DESCRIPTION OF THE PREFERRED EMBODIMENT

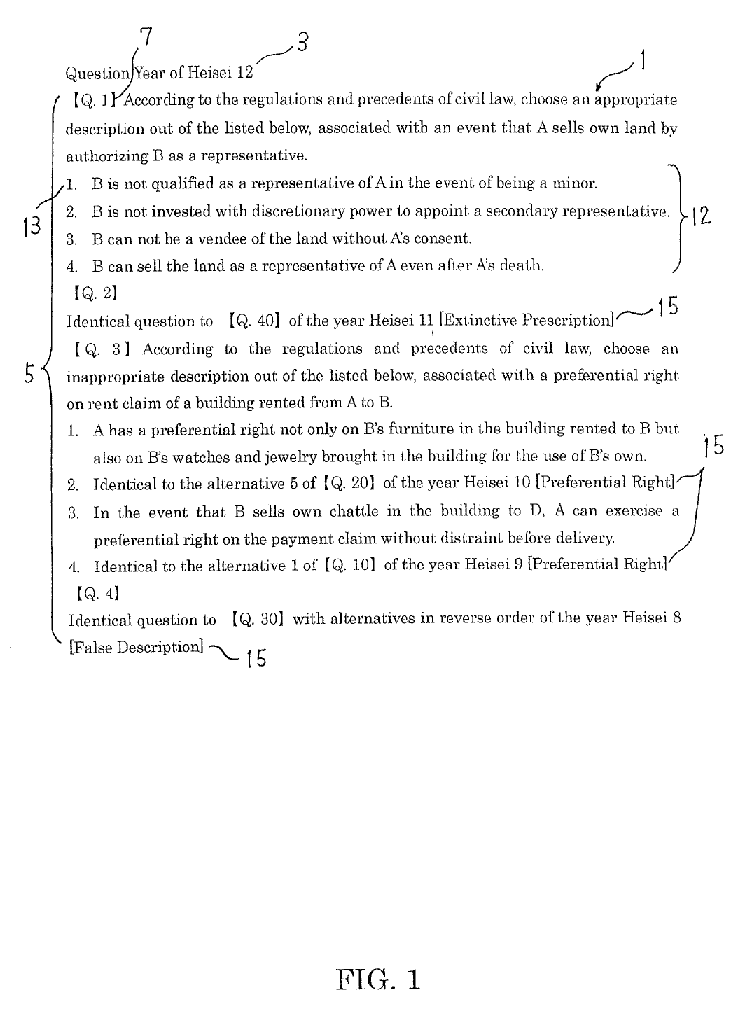

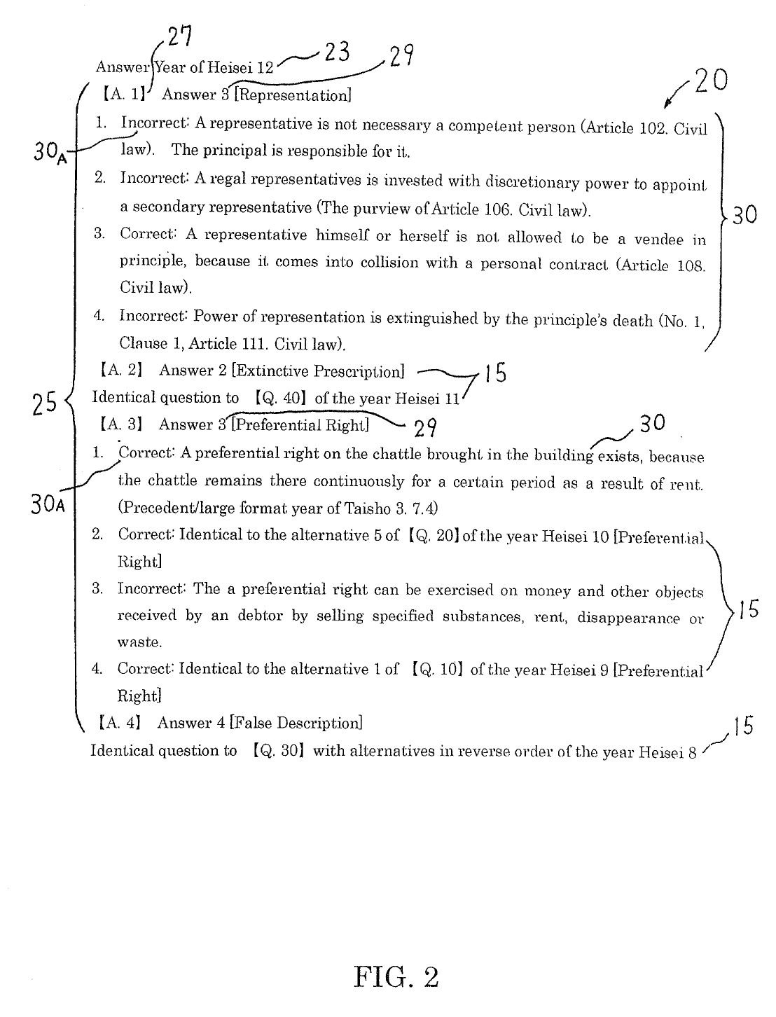

Referring now to FIGS. 1 and 2, a first preferred embodiment of a question reproducible exercise book relating to the present invention is described. The question reproducible exercise book of the present embodiment is a year-by-year question reproducible exercise book in which questions are compiled in order of year. FIGS. 1 and 2 are showing a question reproducible portion and an answer reproducible portion respectively in the year-by-year question reproducible exercise book. As shown in FIG. 1, an item for specifying a period when an examination is held 3 is indicated, for example, year in which an examination is held is indicated in the event of an annual examination, or term and year in which the examination is held in the event of the examination held once in half a year, at a top portion of the question reproducible portion 1 in the year-by-year question reproducible exercise book of the present embodiment. Hereafter, the examination is assumed to be an annual examination in order to simplify the descriptions.

For example, it is assumed that an examination held in the year of Heisei 12 is reproduced here. The period of the examination 3, that is, “Heisei 12” is indicated at the top and questions 5 which are set in the examination held in the year of Heisei 12 follow in order of a real examination. Each of the questions 5 is headed with a question number 7.

Here, “Q. 1” is a question appeared for the first time, that is, a question which has never set in examinations held earlier than the year of Heisei 12. The question comprises a sentence of the question 10 and a plurality of alternatives 12 which are to be chosen as an answer with respect to the question. All the alternatives 12 are provided in horizontal line orientations and listed in the similar order to the real examination. Each alternative number 13 is put on the left side of each alternative 12. An answer is given by the alternative number 13 of an appropriate alternative or by choosing a non-relevant in the event of not finding any appropriate alternative. Incidentally, an answer sheet having the question numbers 7 and alternative numbers 13 is separately prepared for answering the questions by marking the numbers chosen.

“Q. 2” is a question appeared in earlier examinations, that is, a question overlapping in at least one of the examinations held earlier than the year of Heisei 12. Accordingly, indications of the question and the alternatives are omitted and overlapping questions specifying information 15 including year when the examination is held (year of Heisei 11), a question number in the examination (“Q. 4”), and a brief explanation (“Extinctive Prescription”) is indicated instead. Questions in the earlier examinations corresponding to “Q.2” can be referred in the event that details of the question and the alternatives are required.

“Q. 3” is a question having a new configuration in which alternatives set in the examinations held earlier than the year of Heisei 12 are mixed with alternatives appeared in the examination held in the year of Heisei 12 for the first time. The alternatives set in the earlier examinations (item 2, 4) are omitted, and overlapping questions specifying information 15 including year when the examinations are held (Heisei 10, 8), question numbers appeared in the examinations (“Q20”, “Q.10”), brief explanations of the questions (“Extinctive Prescription”) and the like are indicated instead. Alternatives in the earlier examinations corresponding to “Q.3” can be referred in the event that details of the omitted alternatives are required.

“Q. 4” is a question set in examinations held earlier than the year of Heisei 12, in which alternatives are arranged in a different order, for example, in the exact reverse order. Questions and alternatives set in the real examinations are omitted and the overlapping questions specifying information 15 including year when the examination is held (Heisei 8), question number appeared in the examination (“Q30”), an outline of the question (“False Description”), a comment for notifying the fact that the present question is provided with the alternatives arranged in reverse order of the alternatives set in the earlier examination and the like is indicated instead. Questions in the earlier examinations corresponding to “Q.4” can be referred in the event that details of the question and the alternatives are required. Incidentally, there are various kinds of permutation of the alternatives, for example, arranging numbers put on alternatives set in an earlier examination in order as 1, 3, 5, 2, 4.

As shown in FIG. 2, the year (Heisei 12) is indicated as an item 23 for designating the period when the examination is held at the top and followed by answers 25 with respect to the questions corresponding to the order of questions in horizontal line orientations in an answer reproducible portion 20 similar to the above-mentioned question reproducible portion 1 of the year-by-year question reproducible exercise book of the present invention.

Here, “A. 1” corresponds to “Q.1”. As the “Q. 1” is set in the examination held in the year of Heisei 12 for the first time as mentioned above, results whether correct or incorrect 30A with respect to each of the alternatives and brief explanations 30 on which the results are based are indicated in “A. 1” in the similar order of “Q. 1”.

“A. 2” corresponds to “Q.2”. As the “Q. 2” is set in the examination held earlier than the year of Heisei 12 as mentioned above, explanations with respect to each of the alternatives are omitted. Answers of the corresponding questions can be referred in the event that details of the answers are required.

The overlapping questions specifying information 15 including year when the examination is held (Heisei 11), a question number in the examination (“Q. 40”), a brief explanation of the answer (“Extinctive Prescription”) and the like is indicated in the event of necessity. But the overlapping questions specifying information 15 of the question has already been indicated in “Q. 2” of the question reproducible portion 1 and can be omitted.

“A. 3” corresponds to “Q.3”. “Q. 3” is a question having a new configuration in which alternatives set in the examinations held earlier than the year of Heisei 12 are mixed with alternatives appeared in the examination held in the year of Heisei 12 for the first time as mentioned above. Therefore, the results whether correct or incorrect 30A with respect to each of the alternatives (“Alternatives 1, 3”) and the brief explanations 30 on which the results are based are indicated. And as for the alternatives (“Alternatives 2, 4”) set in the examinations held earlier than the year of Heisei 12, only the result whether correct or incorrect 30A with respect to the alternatives are indicated and the brief explanations with respect to the results are omitted. The explanations of the alternatives corresponding to the question set in the earlier examination can be referred in the event that details of the explanations with respect to the omitted alternatives are required.

Further, the overlapping questions specifying information 15 has already been indicated in “Q. 3” and can be omitted in the same manner as mentioned above.

“A. 4” corresponds to “Q.4”. “Q. 4” is a question set in examinations held earlier than the year of Heisei 12, in which the alternatives are arranged in a different order, for example, in the exact reverse order as mentioned above. Therefore, the results and the explanations with respect to each of the alternatives are omitted. And the overlapping questions specifying information 15 including a comment 38 for notifying the fact that the present question is provided with the alternatives arranged in reverse order of the alternatives set in the earlier examination, year when the examinations is held (Heisei 8), number of the question appeared in the earlier examinations (“Q30”), and an outline of the question (“False Description”) is indicated instead.

In the event of learning the examination questions sequentially in order of year using a first example of the above-mentioned question reproducible exercise book, as the overlapping questions specifying information with respect to the questions or alternatives set in the earlier examinations is indicated, the questions and the alternatives are recognized as previously answered and can be omitted, thereby saving time and effort of learning.

Additionally, questions and alternatives overlapping in several examinations are considered quite important, thereby grasping tendency of the questions easily.

Incidentally, a first question reproducible exercise book shown as the present example is assumed to be edited in increasing order of year, and the questions and the alternatives of the earlier examinations appearing repeatedly in ensuing pages are omitted and replaced by the overlapping questions specifying information. However, in the event that the question reproducible exercise book is edited in decreasing order of year, the questions and the alternatives of the later examinations appearing repeatedly in ensuing pages can be omitted and replaced by the overlapping questions specifying information as a matter of course.

Further, the overlapping questions specifying information can be indicated at a portion of corresponding questions and alternatives on which the overlapping questions specifying information is based (for example, “Q. 40” of the year Heisei 11 which is specified as an overlapping question in “Q. 2”), thereby grasping the tendency of the question easily (for example, “Q.2” of the year Heisei 12 is indicated at the question reproducible portion of “Q. 40” of the year Heisei 11 are appended).

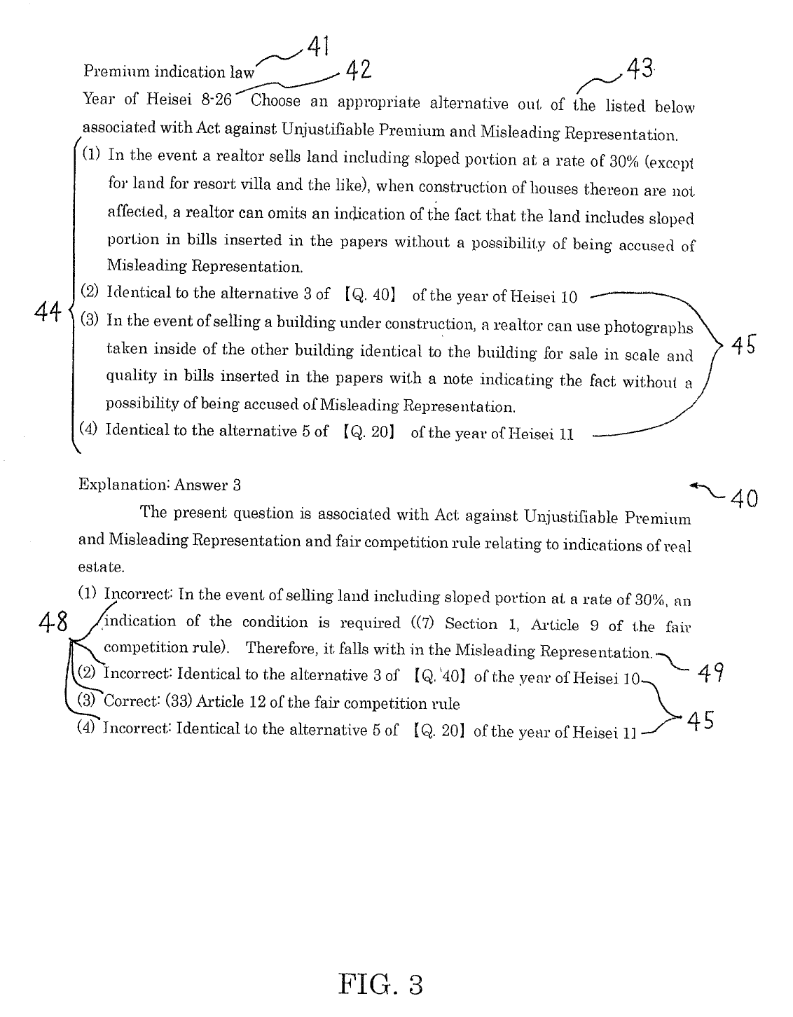

Referring now to FIG. 3, a second preferred embodiment of a question reproducible exercise book relating to the present invention is described. The question reproducible exercise book of the present embodiment is a category-by-category question reproducible exercise book 40 in which questions are compiled by category. Questions which have been set in examinations up to present time are classified by category or theme and compiled in the category-by-category question reproducible exercise book. In the event that a plurality of questions are compiled in one category or in one theme, each portion of the category or the theme is further arranged in order of year. In a question reproducible portion, a heading of a category 41 of the examination question is indicated firstly and year 42 when the examination is held is indicated secondly. Then indications of questions 42, alternatives 44 and overlapping questions specifying information 45 follow thereafter. A conclusion 47, results of each of the alternatives 48 and explanations 49 are indicated in an answering portion, and the overlapping questions specifying information 45 is indicated again in the event of necessity.

A method of indicating questions appeared for the first time, questions set in the earlier examinations, questions accompanied by alternatives arranged in different order, and answers in the category-by-category question reproducible exercise book 40 are generally similar to the indicating methods in a question reproducible portion and an answer reproducible portion in the year-by year question reproducible exercise book of the first embodiment. Accordingly descriptions of each of the questions and answers are omitted here.

As the questions in the category-by-category question reproducible exercise book are classified by category and arranged in order of year in each category, tendencies of the examination questions can be easily grasped, in the event of learning the questions which is set in the earlier examinations sequentially in order of year by using the above-mentioned category-by-category question reproducible exercise book. And in the above-mentioned category-by-category question reproducible exercise book, indications of the questions and alternatives set in the earlier examinations are omitted and the overlapping questions specifying information is indicated instead similarly to the year-by-year question reproducible exercise book. Therefore, learners can recognize that the question has ever been answered and omitted, thereby saving time for learning and regarding the questions and alternatives with importance.

Further, as the questions are edited by category in the question reproducible exercise book of the present example, the overlapping important questions appear in an identical portion with a high probability, thereby allowing recognition of the above-mentioned overlapping questions easier and grasping the tendency of the examinations more effectively.

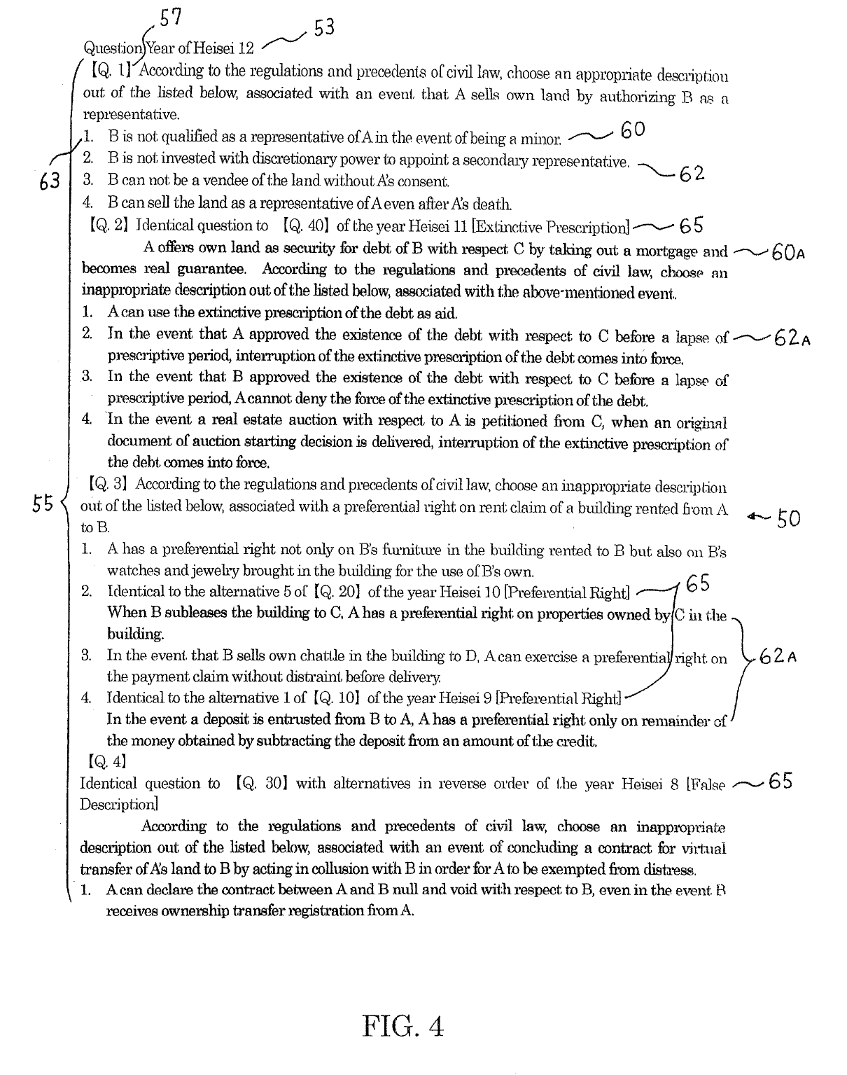

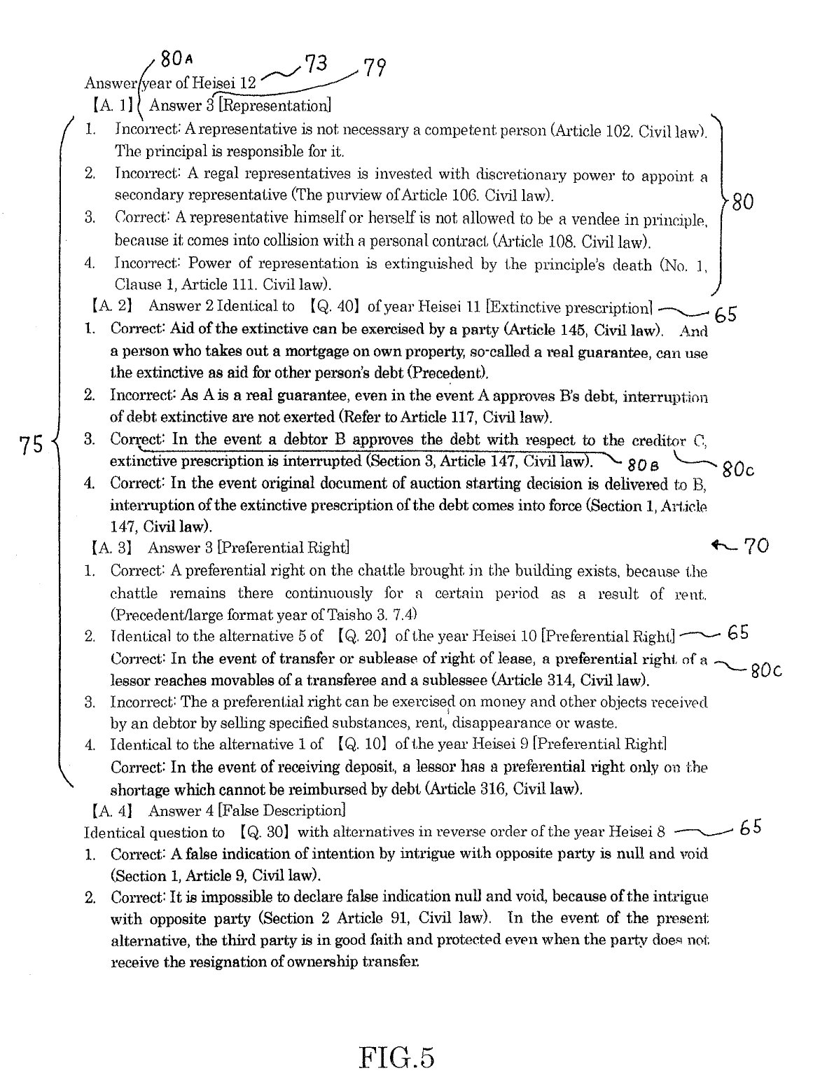

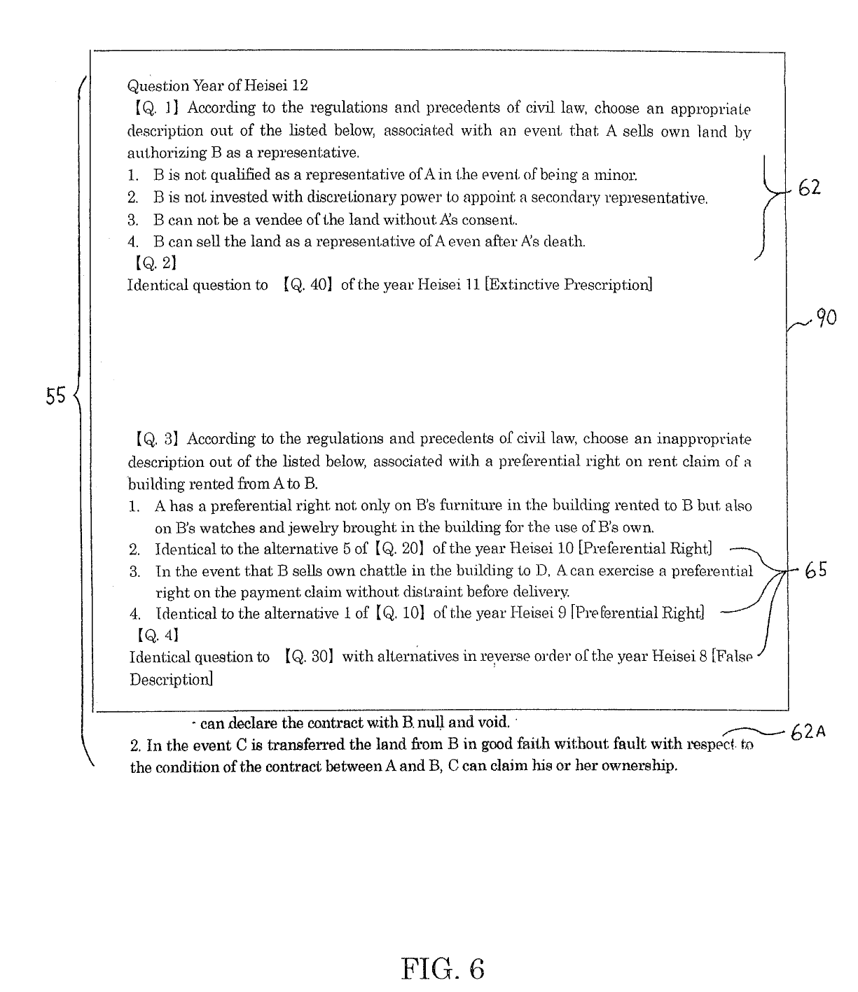

Referring now to FIGS. 4, 5 and 6, a third preferred embodiment of a question reproducible exercise book relating to the present invention is described. The question reproducible exercise book of the present embodiment is a tow-colored year-by-year question reproducible exercise book in which questions are compiled in order of year and printed in two colors. FIG. 4 shows a question reproducible portion 50 in the year-by-year question reproducible exercise book and FIGS. 5 and 6 show an answering portion and usage condition of the question reproducible portion 50, respectively.

As shown in FIG. 4, in the event that the questions of the examination held in the year of Heisei 12 are supposed to be reproduced in the question reproducible portion 50 in the tow-colored year-by-year question reproducible exercise book relating to the present invention, year when the examination is held 53, that is, “the year of Heisei 12” is indicated at the top and questions 55 set in the above-mentioned examination are listed in horizontal line orientations thereafter. And question numbers 57, sentences of the questions 60 and alternatives 62 with respect to the questions are indicated respectively in the questions 55. Further, each question is answered by choosing an appropriate alternative among a plurality of alternatives 63 to which alternative numbers 62 are appended or by choosing a non-relevant in the event of not finding an appropriate alternative. Incidentally, the questions are answered by marking numbers chosen on an answer sheet.

Here, “Q. 1” is a question appeared in the examination held in the year of Heisei 12 for the first time and reproduced straight from the real examination and indicated, for example, in an ordinary black color.

“Q. 2” is a question set in the earlier examinations, that is, a question overlapping in more than one examination held earlier than the year of Heisei 12. A question sentence 60A and an alternative 62A are indicated in a color, for example, a red color which is different from “Q. 1” by monochrome printing. Further, in the event of necessity, the overlapping questions specifying information 65 including year when the examination is held (Heisei 11), a question number in the examination (“Q. 40”) and a brief explanation of the question (“Extinctive Prescription”) is indicated in an identical color, that is, an ordinary black color similar to the question 11. However, the above-mentioned overlapping question specifying information 65 can be indicated only in an answer portion 70 as will be mentioned below by reason of limited marginal space for a description in the present embodiment.

“Q. 3” is a question having a new configuration in which alternatives set in the examinations held earlier than the year of Heisei 12 are mixed with alternatives appeared in the examination held in the year of Heisei 12 for the first time. Alternatives (Alternatives 1, 3) set in the examination held in the year of Heisei 12 for the first time is indicated in a black color ordinarily by monochrome printing similar to “Q. 1” and alternatives (Alternatives 2, 4) which have ever set in the examinations held earlier than the year of Heisei 12 are indicated in a red color by monochrome printing similar to “Q.2”. The overlapping questions specifying information 65 including years when the examinations are held, question numbers and alternative numbers in the examinations (Heisei 10 “Q. 20” alternative 5, and Heisei 9 “Q. 10” alternative 1), and outlines of the questions (“Extinctive Prescription”) which is indicated in a black color by ordinary monochrome printing are appended respectively to alternative numbers (Alternatives 2, 4) which have ever set in the examinations held earlier than the year of Heisei 12. Incidentally, the above-mentioned overlapping question specifying information 65 can be indicated only in an answer portion 70 by reason of limited marginal space for a description in the present embodiment as mentioned above.

“Q. 4” is a question set in examinations held earlier than the year of Heisei 12, in which alternatives are arranged in a different order, for example, in the exact reverse order and indicated in, for example, a red color by monochrome printing similarly to “Q.2”.

Additionally, the overlapping questions specifying information 65 including a comment for notifying the fact that the present question is provided with the alternatives arranged in the reverse order of the alternatives set in an earlier examination in the event of necessity, year when the examination is held, a question number appeared in the examination, and an outline of the question is indicated in an identical color, that is, a black color by monochrome printing. Incidentally, the above-mentioned overlapping question specifying information 65 can be indicated only in an answer portion 70 by reason of limited marginal space for a description as mentioned above.

As shown in FIG. 5, in the answer reproducible portion 70 of the year-by-year question reproducible exercise book of the present embodiment, year when the examination is held 73 is indicated at the top and answers 75 with respect to the questions in the examination held in the above-mentioned period are listed in horizontal line orientations thereafter. And numbers of the answers 77, conclusions 79, results 80A whether correct or incorrect with respect to the alternatives, and brief explanations 80 are indicated respectively in the portions of the answers 75.

Here, “A. 1” corresponds to “Q. 1”. As “Q.1” is a question set in the examination held in the year of Heisei 12 for the first time as mentioned above, “A. 1” is indicated in a black color by ordinary monochrome printing.

“A. 2” corresponds to “Q. 2”. As “Q. 2” is an overlapping question reproduced straight from the examination held earlier than the year of Heisei 12, results whether correct or incorrect 80B with respect to each of the alternatives and brief explanations 80C of “A. 2” on which each of the alternatives are based are indicated in a color, for example, a red color different from “A. 1” by monochrome printing. Further, the overlapping questions specifying information 65 including the year when the examination is held (Heisei 11), the question number in the examination (“Q. 40”) and the brief explanation of the question (“Extinctive Prescription”) is indicated in a color, that is, an ordinary black color, identical to “Q. 1” by monochrome printing.

Incidentally, as for “A. 2”, indications of the above-mentioned results 80B with respect to each of the alternatives and the brief explanations 80C can be omitted and only the overlapping questions specifying information 65 can be indicated in ordinary monochrome printing by reason of limited marginal space for a description as mentioned above.

“A. 3” is an answer with respect to “Q. 3”. “Q. 3” is a question having a new configuration in which alternatives set in an examination held earlier than the year of Heisei 12 are mixed with alternatives appeared in the examination held in the year of Heisei 12 for the first time. Results whether correct or incorrect with respect to the alternatives for the first time and brief explanations appeared in the examination are indicated in a black color similar to “A. 1” by ordinary monochrome printing. And results whether correct or incorrect with respect to the alternatives appeared in the earlier examinations and brief explanations are indicated in, for example, a red color similar to “A. 2” by monochrome printing and the overlapping questions specifying information 65 including year when the examination held, a question number in the examination, alternative numbers accompanying the question and an outline is indicated in a color, that is, an ordinary black color, identical to “A. 1” by monochrome printing., while brief explanations 80C can be omitted as mentioned in a description of “A. 2”.

“A. 4” is an answer with respect to “Q.4”. “Q. 4” is a question set in an examination held earlier than the year of Heisei 12, in which the alternatives are arranged in different order, for example, in the exact reverse order. The results whether correct or incorrect with respect to the alternatives and brief explanations in “A. 4” are indicated in, for example, a red color by monochrome printing. And the overlapping questions specifying information 65 including a comment for notifying the fact that the present question is provided with the alternatives arranged in reverse order of the alternatives set in the earlier examination, year when the examination is held, question number appeared in the examination, and an outline of the question is indicated instead in a black color. The overlapping questions specifying information 65 can also be indicated in an ordinary black color by monochrome printing as a matter of course.

Referring now to FIG. 6, an event of using a red transparent sheet 90 in the two-colored year-by-year question reproducible exercise book printed in colors of black and red. The red transparent sheet 90 manufactured of, for example, a red transparent plastic plate or cellophane having a size at least enough to cover a whole portion of a question in the question reproducible portion or the answer portion. When the red transparent sheet is put on the question reproducible portion 50 of the present embodiment, letters printed in a black color are seen through but letters indicated in a red color by monochrome printing are invisible. The portions printed in a red color can be invisible by using the red transparent sheet.

In the event of learning by using the two-colored year-by-year question reproducible exercise book of the present embodiment, there is nothing wrong in using or not using the red transparent sheet. In the event of not using the red transparent sheet, learning by a method similar to the event of monochrome-printed year-by-year question reproducible exercise book is available. However, as the questions and alternatives set in the earlier examinations are printed and indicated in a red color, the questions and alternatives can be discriminated easily, thereby being suitable for learning intensively by focusing attention thereon.

Further, in the event of using the red transparent sheet, the questions and alternatives set in the earlier examinations become invisible while only the questions and alternatives appeared in the examination for the first time and the overlapping specifying information can be seen. Therefore, a learner does not have to learn the questions and alternatives overlapping in the earlier examinations more than one time, thereby bringing efficiency and quickness to the learning particularly in the event of leaning just before an examination and the like.

Incidentally, in the third preferred embodiment of the present invention, although the year-by-year question reproducible exercise book is printed in two colors, the category-by-category question reproducible exercise book can also be printed in two colors as a matter of course.

Further, the above-mentioned two-colored question reproducible exercise book in which the questions and alternatives appeared in a particular examination for the first time and the questions and alternatives set in the earlier examinations are printed in two colors of red and black respectively can be published as a three-colored question reproducible exercise book in which particularly important items or special subjects to memorize are printed in a color, for example, a blue color different from the above-mentioned two colors. In the above-mentioned event, portions printed in a blue color become invisible by using a blue transparent sheet. Thus intensive leaning and rote learning become easier by making the questions and alternatives invisible partly.

The above-mentioned particularly important items and the special subjects to memorize include, for example, the text of cause for a law examination, important English words for a language test and the like.

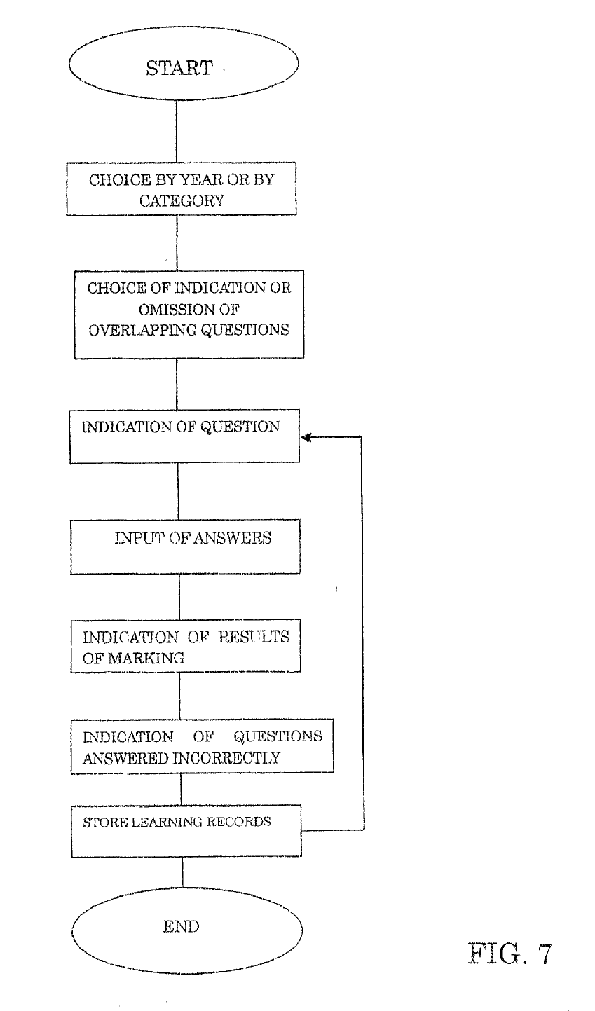

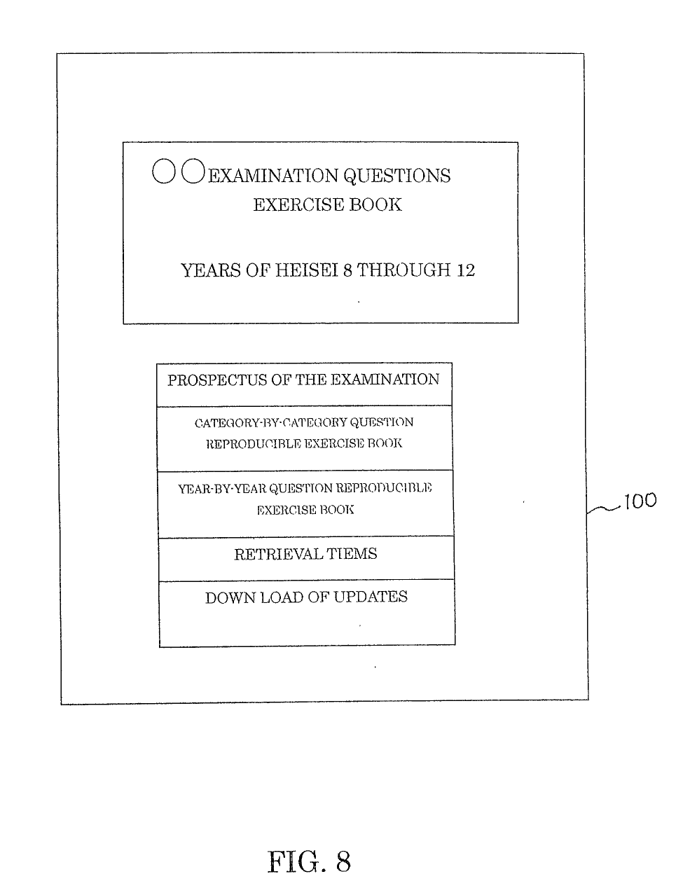

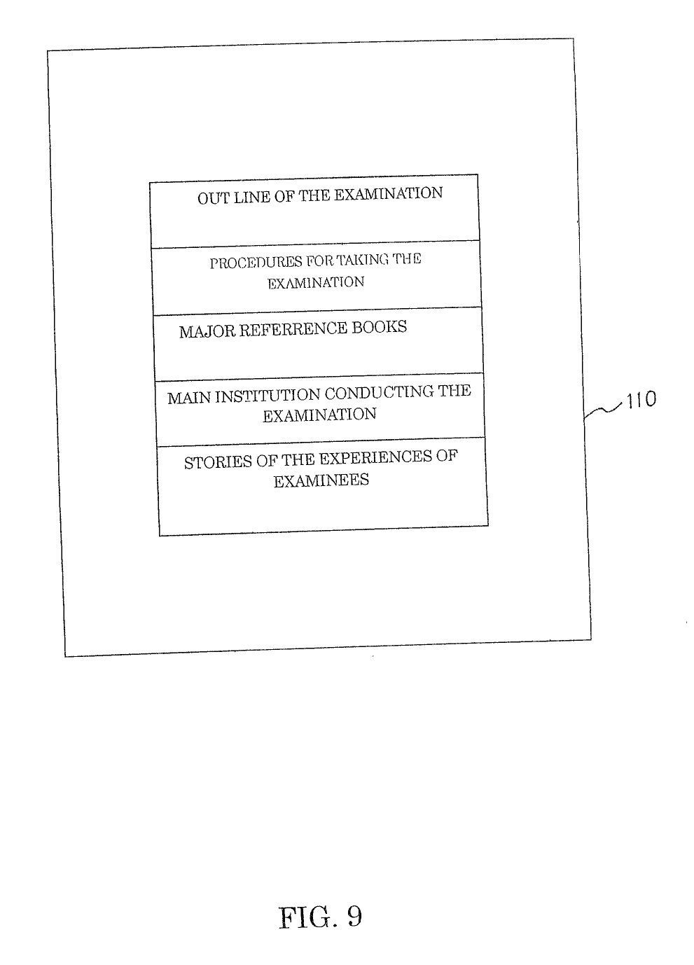

FIG. 7 is a system block diagram for illustrating a question reproducible system of a fourth embodiment of the present invention, and FIGS. 8 and 9 are illustrated examples of a display screen of the system. System requirements of the question reproducible system of the present embodiment include al least a main unit of a computer, a display device, and an inputting device. The question reproducible system of the present embodiment is stored in a removable recording medium such as a CD-ROM, a floppy disk and the like or in a non-removable recording medium such as hard disk and the like. And the system is started up via a predetermined drive after the computer boots up.

FIG. 8 shows a first display screen 100 of the question reproducible system of the present embodiment including items of a prospectus of an examination, the year-by-year question reproducible exercise book, the category-by-category question reproducible exercise book, a retrieving item, download of updates and the like. When one of the above-mentioned items is clicked, another page displaying more detailed items is indicated. For example, when the item of “a prospectus of an examination” is clicked, the display screen 110 displaying various items associated with the information of the examination, for example, general information of the examination, procedures for taking the examination, major reference books, main institutes of the examination, stories of passing the examination and the like shows up, as shown in FIG. 9. When a desired item in the above-mentioned display screen 110 is clicked, further details associated with the respective items are indicated.

Further, when the item of “a question reproducible exercise book” is clicked, compiled questions of an examination held in a particular year are listed up in the display screen. For example, in order to indicate a question reproducible exercise book of year of Heisei 12, all the learner has to do is to click the item of “year of Heisei 12”.

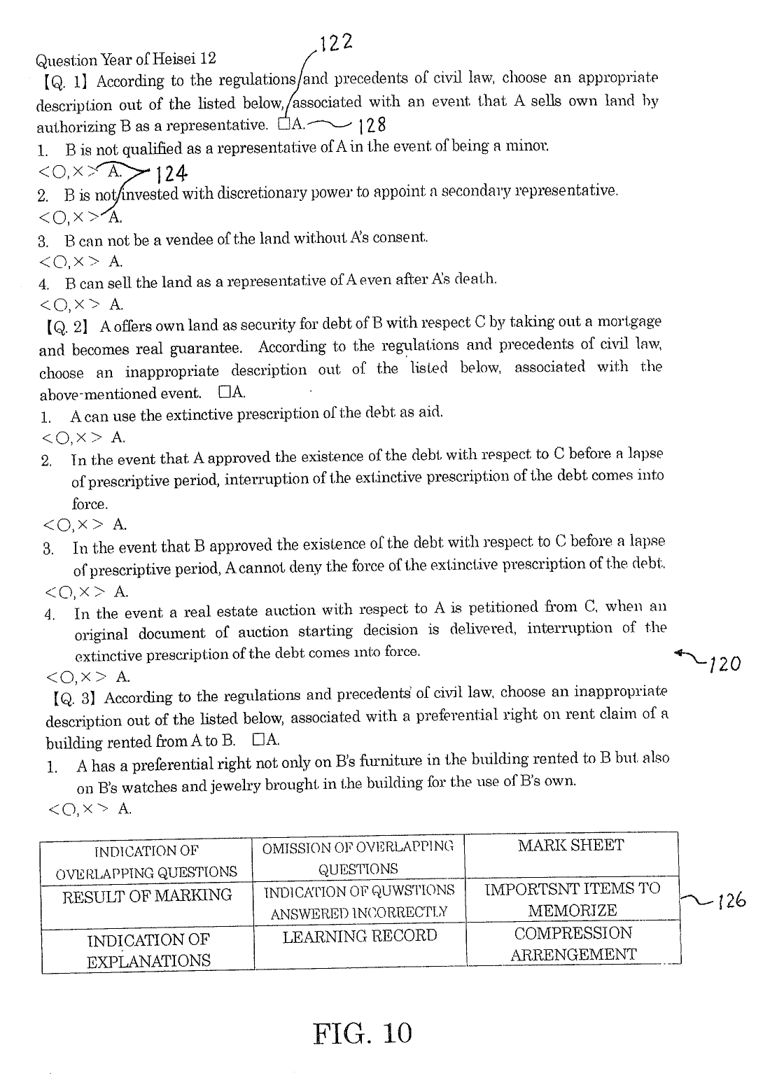

In the above-mentioned display screen 120, time when the question is set, numbers of the question, question sentences and alternatives with respect to each of the questions are indicated, and an examination question set straight from the real examination held in the year of Heisei 12 is indicated in an ordinary color, for example, a black color, as shown in FIG. 10. Additionally, in the display 120, a box 122 for inputting “a conclusion” and a section 124 for choosing “a result whether correct or incorrect with respect to each alternative” are provided at the end of each question sentence and each alternative respectively in order to input an answer of the learner's own on the screen by operating a key board. Further, on the above-mentioned display screen, items 126 as “an indication of overlapping questions”, “an omission of overlapping questions”, “a mark sheet”, “a result of marking”, “an indication of an explanation”, “an important item to memorize”, “an indication of an incorrect answer”, “leaning records” and the like are programmed.

Here, when a learner clicks the item of “an indication of overlapping questions” on the display screen, questions and alternatives overlapping in examinations held earlier and later than a particular examination are indicated in a converted color, for example, a red color different from other question reproducible portions. On the above-mentioned display screen, the questions are indicated in generally similar manner of the indication shown in the above-mentioned FIG. 4.

On the other hand, when the item of “an omission of overlapping questions” is clicked, the overlapping questions and alternatives are omitted, and the overlapping questions specifying information including year when a particular examination was held, a question number and an alternative number in the examination, an outline of the question, and comments for notifying the fact that the question is arranged in reverse order or by permutation is indicated instead. On the above-mentioned display screen, the questions are indicated in generally similar manner of the indication shown in the above-mentioned FIG. 1.

In the event of using the present question reproducible system, learners can learn depending on each learning progress in a proper way of indicating the questions by indicating all questions, by omitting the overlapping questions, or by indicating the overlapping questions in a different color.

The question can be answered, for example, by clicking a mouse for choosing either of ◯ in the event of an appropriate alternative or x in the event of an inappropriate alternative indicated in the section 124 of “a result whether correct or incorrect with respect to each alternative” provided at the end of each alternative, and further by inputting an alternative number of correct answer with respect to the question or 0 in the event of non-relevant in the box 122 of “a conclusion” provided at the end of each question sentence.

On the other hand, when the item of “a mark sheet” is clicked, for example, a mark sheet adopted in the real examination is indicated in a corner of the display screen. And the whole answers can be input by choosing the numbers provided on the sheet, thereby adding a sense of realism in learning.

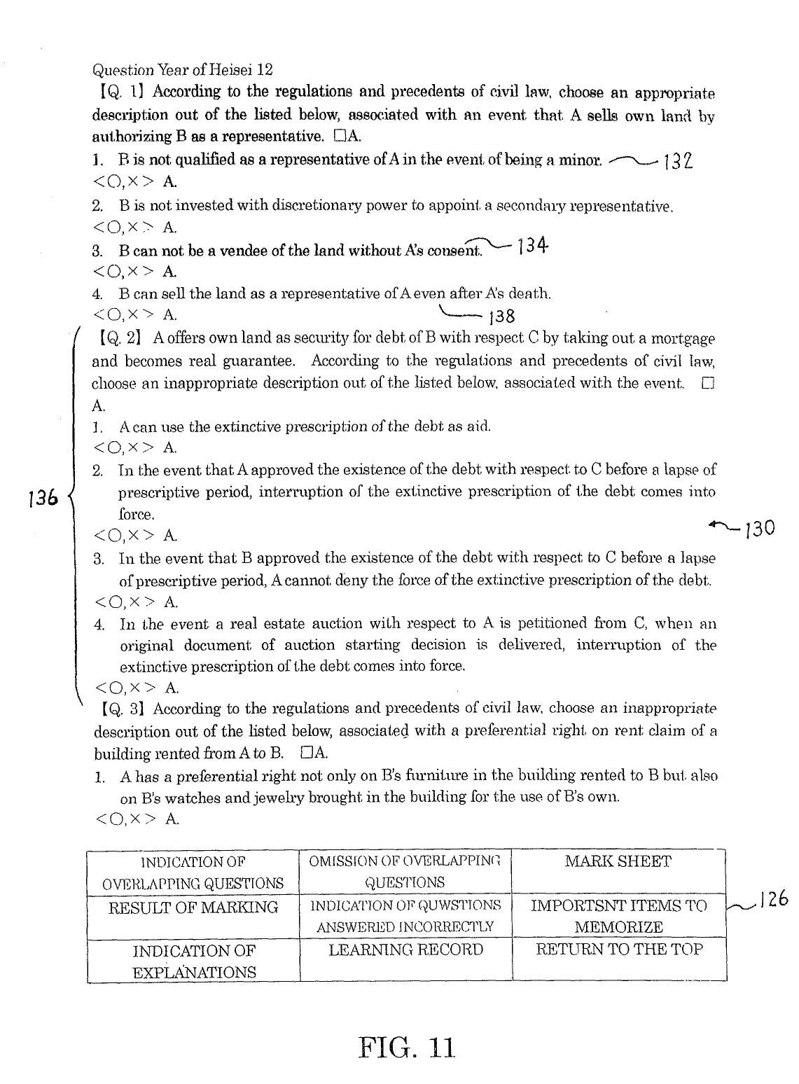

When the item of “result of marking” is clicked after a learner completes answering one of the questions or the whole questions of the examination held in a particular year (the whole questions in a particular category, in the event of the category-by-category question reproducible portion), questions answered correctly 136 and alternatives chosen appropriately 138 remain indicated in a black color on one hand, and question sentences answered incorrectly 132 and alternatives chosen inappropriately 133 are indicated in a different color, for example, a red color (or still another color, for example, a blue color, in the event that a red color has already used for indicating the overlapping questions) on the screen 130, as shown in FIG. 11. Therefore, the learner can try answering the questions by focusing only on the portions answered incorrectly, which enables the learner to learn effectively.

When the item of “an indication of a brief explanation” is clicked, a display including numbers of the whole questions in a particular examination, conclusions of each of the questions, results whether correct or incorrect of each of the alternatives, and brief explanations on which the results are based is indicated on the screen.

Incidentally, for referring to each brief explanation at each time after answering a question or choosing an alternative, a mark of “A.” 128 is provided at rearmost portion of each item of “a conclusion” 122 following to a question sentence and each item of “a result whether correct or incorrect with respect to each alternative” 124 following to each alternative.

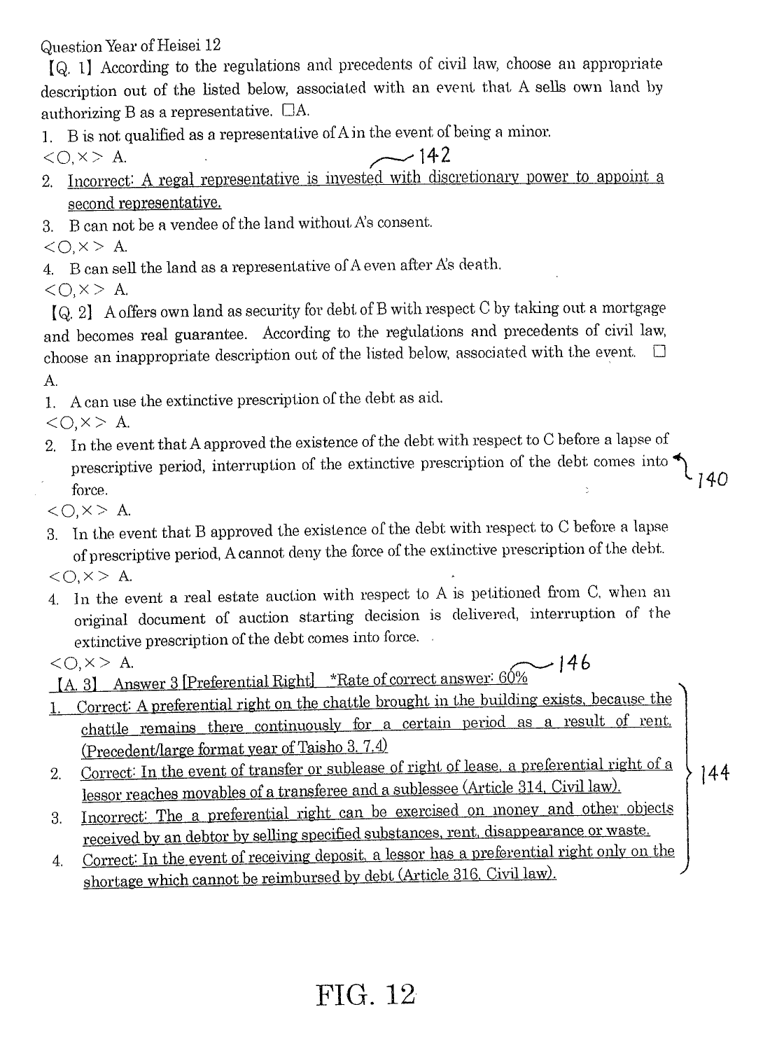

In the above-mentioned event, a screen 140 as shown in FIG. 12 shows up and displays explanations 144 and 142 associated only to the question and the alternative chosen by clicking the above-mentioned mark of “A.” are indicated instantly for learner's convenience. Incidentally, various kinds of information associated with the question, such as a rate of correct answers 146 in the real examination held earlier and the like can be indicated concurrently as a reference of learning.

Further, when the item of “an important item to memorize” is clicked, in addition to a display including the year when a particular examination is held, question numbers, conclusions of each of the questions, results whether correct or incorrect with respect to each of the alternatives, and brief explanations on which the results are based (that is, similar to the above-mentioned display of “an indication of a brief explanation”), items which are extremely important or necessary to be memorized are indicated in a color, for example a blue color, different from other portions for answers.

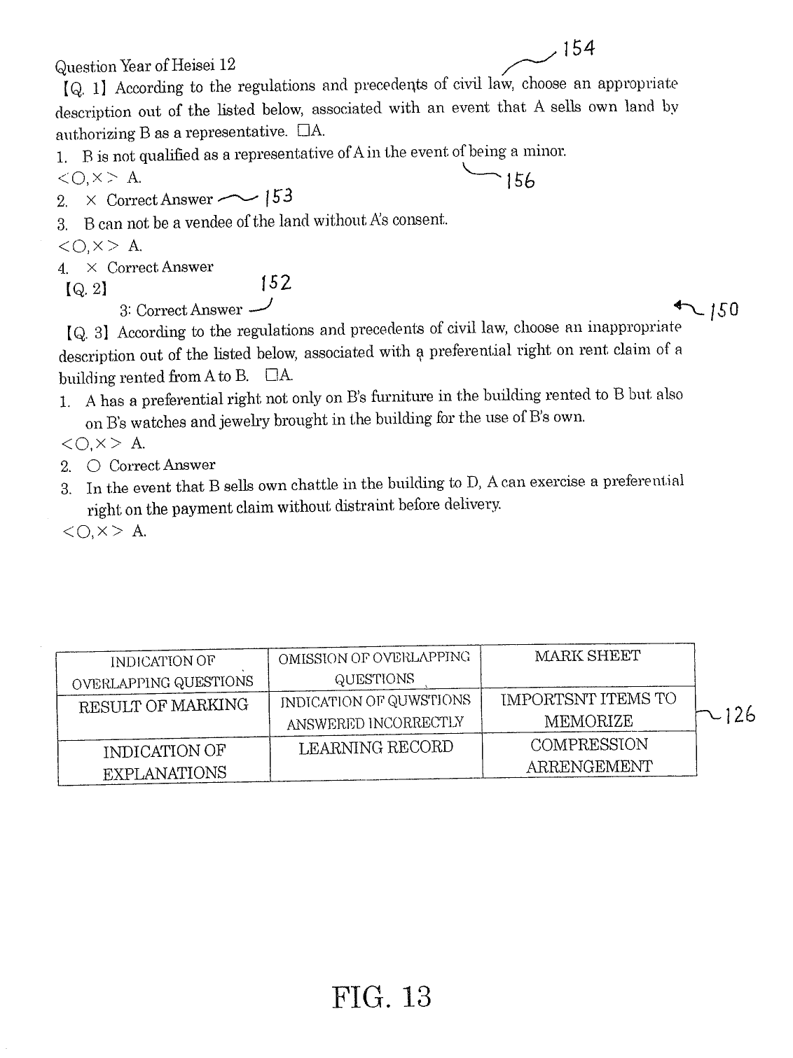

On the other hand, learners can click the item of “an indication of an incorrect answer” in the present question reproducible system. In the above-mentioned event, as shown in FIG. 13, indications of question sentences answered correctly are erased and only a correct answer is indicated when necessary. Further, only question sentences 154 and alternatives 156 which cause incorrect answers are indicated with respect to the questions answered incorrectly, and only correct answers 153 are indicated with respect to alternatives chosen correctly.

In the display screen 150, when an item of “compression organizing” is clicked, the questions answered correctly and alternatives chosen properly are erased and spaces between the alternatives left in the display are compressed in order to display the indication in an organized form.

The questions and alternatives leading to the incorrect answers normally represent the learner's incomplete understanding and leads to incorrect answers again in most cases. Therefore, the display screen of “an indication of an incorrect answer” 150 is provided in order to enable the learner to learn effectively.

Further, when the item of “learning record” is clicked, a file of leaning record is opened, in which a reminder 162, for example, an identification number such as a date and the like and sentences that too much time is spent or too many mistakes are made for answering the question and the like are attached can be stored.

Furthermore, in the present question reproducible system, the display screen of “an indication of an incorrect answer” 150 provides the items of “an indication of overlapping questions”, “an omission of overlapping questions”, “a mark sheet”, “a result of marking”, “an indication of an explanation”, “an important item to memorize”, “an indication of an incorrect answer”, “compress organizing” and the like.

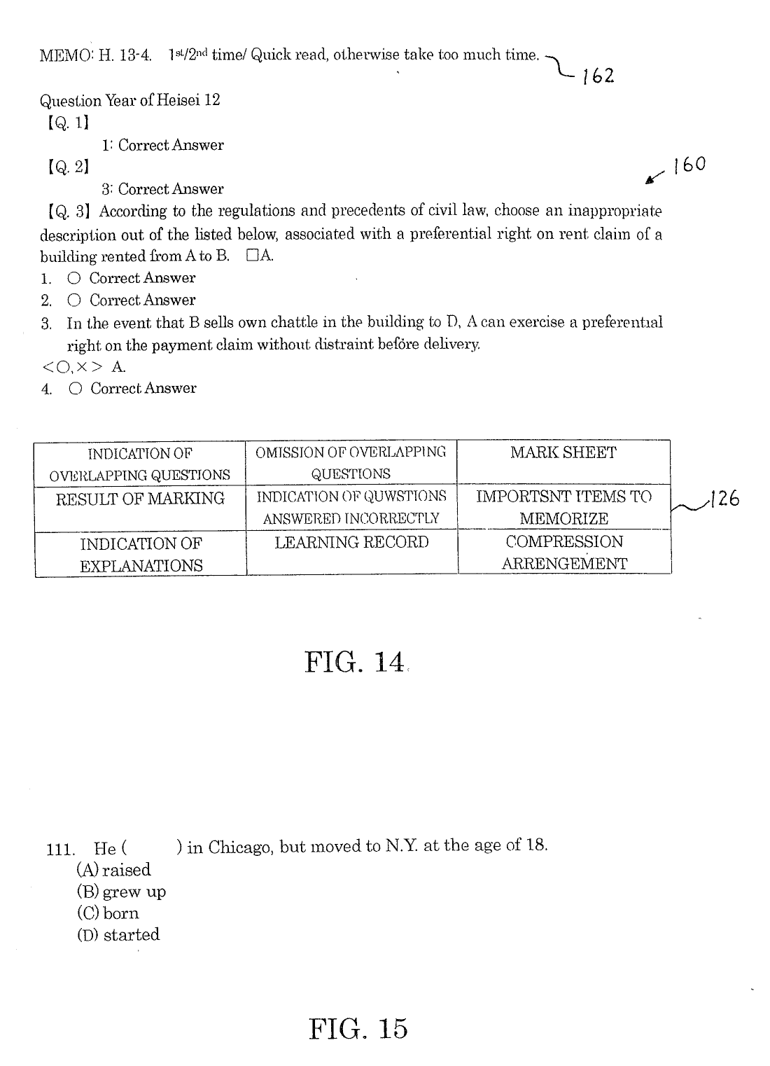

The above-mentioned display screen of the item “an indication of questions answered incorrectly” 150 indicates the result of the questions answered previously. And a learner can input answers again and click the item of “an indication of questions answered incorrectly” again in order to indicate questions and alternatives answered incorrectly further again, in another display screen of “an indication of questions answered incorrectly”, as shown in FIG. 14. The above-mentioned second display screen of “an indication of an incorrect answer” 160 can be stored in the file of learning record as a matter of course. Therefore, learners can narrow down the questions regarded as the weak points and learn effectively by repeating above-mentioned procedures.

When the item of “category-by-category question reproducible portion” is clicked, a screen for displaying a desired “category” of the questions compiled in the system shows up. And when a particular “category” out of the listed is clicked, questions compiled in the “category” appear in order of year.

Operations of sections for inputting “a number of the answer” and “result whether correct or incorrect with respect to alternatives” and items of “an indication of overlapping questions”, “an omission of overlapping questions”, “a mark sheet”, “a result of marking”, “an indication of an explanation”, “an important item to memorize”, “an indication of an incorrect answer”, “compress organizing” and the like in the screen of “category-by-category question reproducible portion” are similar to the operations in the screen of “year-by-year question reproducible portion”, whose descriptions are abbreviated here.

Further, when an item of “retrieval” in the first screen is clicked, a frame for inputting a retrieval item is indicated with items of a table of contents, category, year and the like. When a desired retrieval item is found in the items of “a table of contents” and “category” and clicked thereon, all questions associated with the retrieval item are listed up and an explanation of the retrieval item is indicated. On the other hand, in the event that the retrieval item is not found, a desired word can be input in the frame of “retrieval item” and the item of “retrieval” can be clicked. The particular word is assumed to be similar to the above-mentioned extremely important items or items to memorize.

Finally, the item of “download of updates” is described as below. When the item of “download of updates” is clicked, another item of “desired year to be downloaded” is indicated. Learners who have purchased the present question reproducible system previously can download an updated question reproducible system to a proper recording medium, for example, a hard disk by inputting programmed ID number and clicking the item of “download”. Once a learner purchases a CD-ROM storing the present question reproducible system, the learner can obtain the latest information associated with an updated question reproducible system at any time and is not bothered by buying a new question reproducible system every year.

Incidentally, it is needless to say that “an indication of an incorrect answer” function in the question reproducible system according to the present invention is applicable not only to the question reproducible exercise book for exercising examination questions set in examinations held periodically, but also to all kinds of examination questions exercise books, examination simulating books and drill books which take the form of answering a question by choosing an appropriate alternative among a plurality of alternatives.

While several preferred embodiments of the question reproducible exercise book and the question reproducible system relating to the present invention have been described above, such description is for illustrative purposes only, and it is to be understood that changes and variations may be made without departing from the spirit or scope of the present invention.

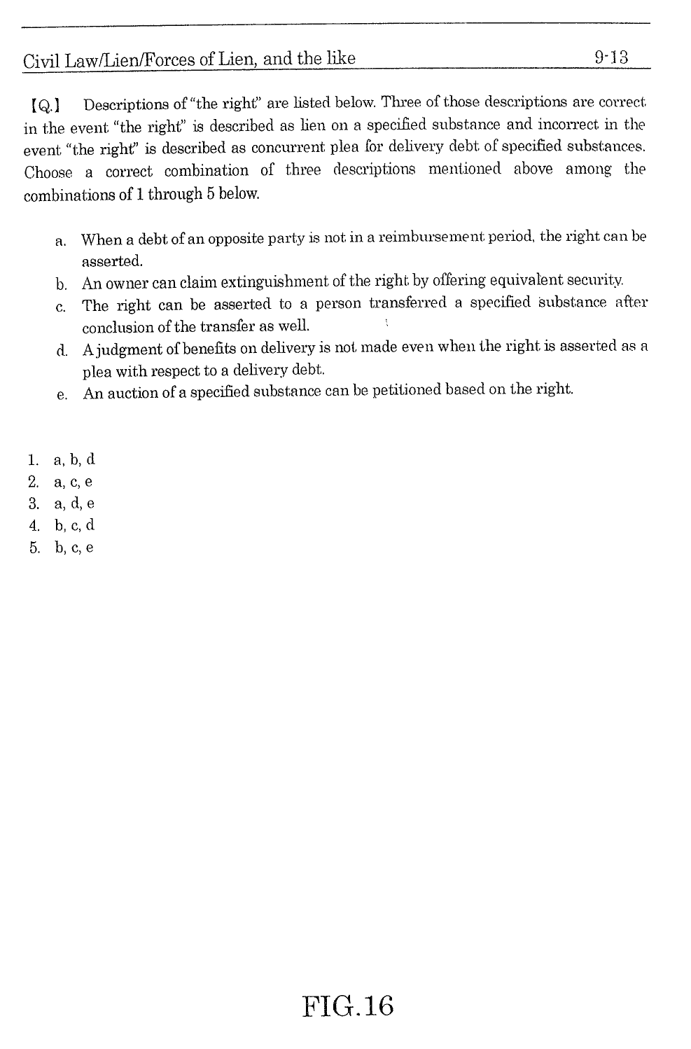

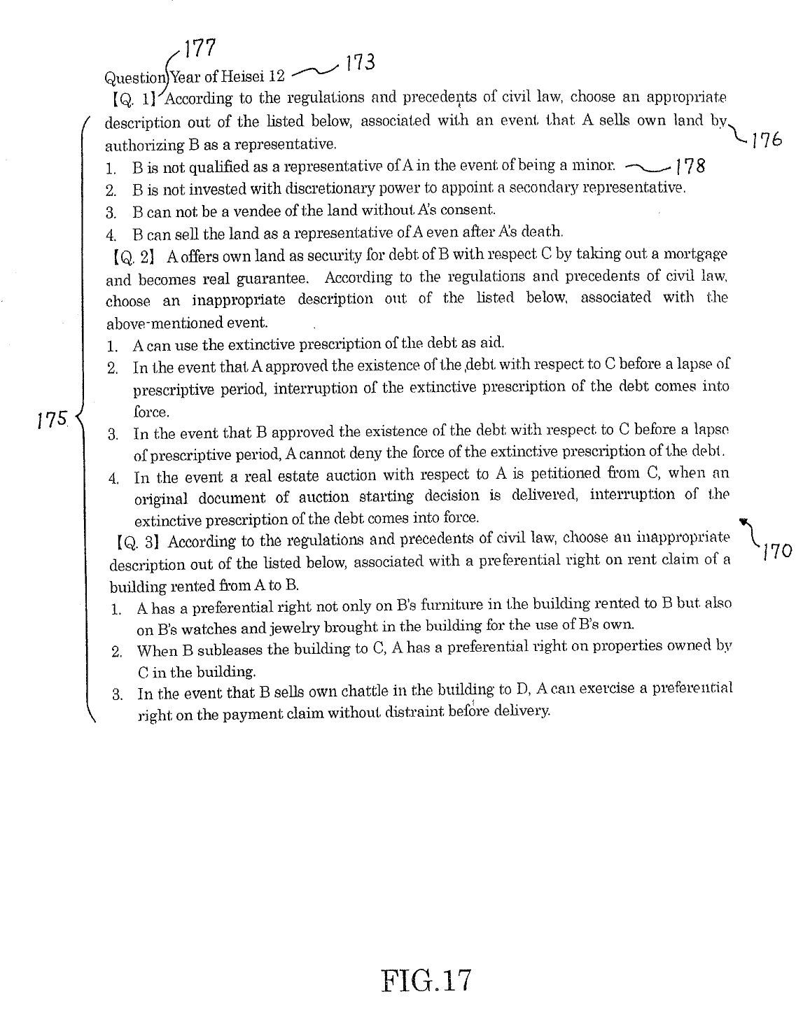

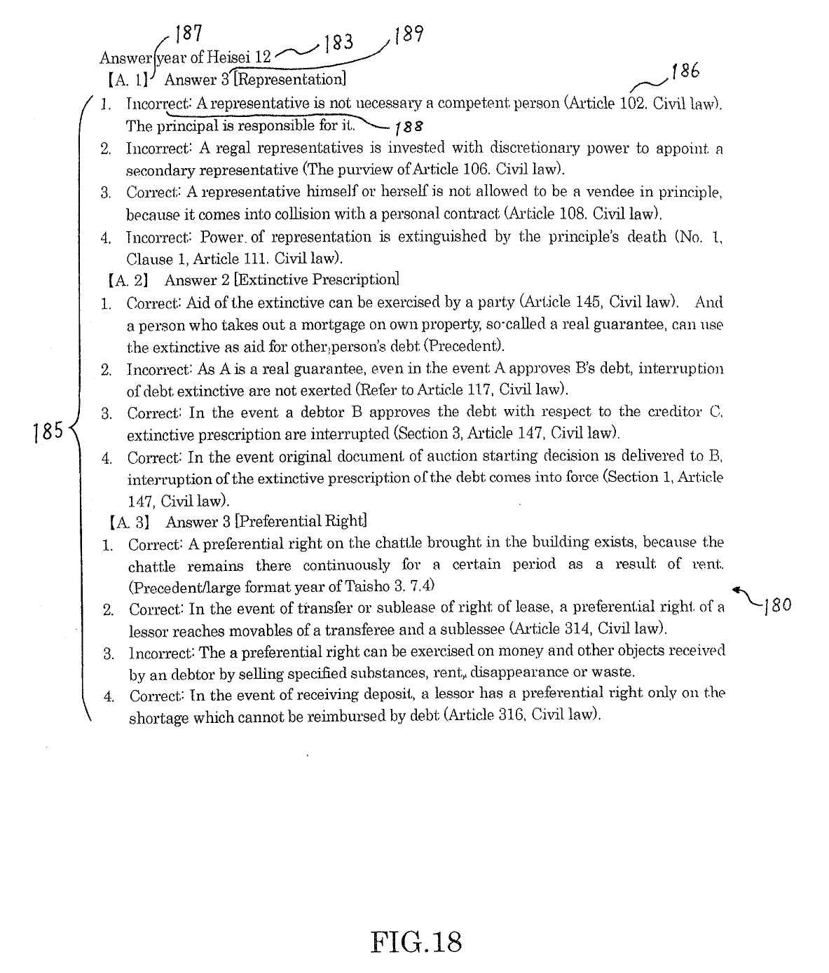

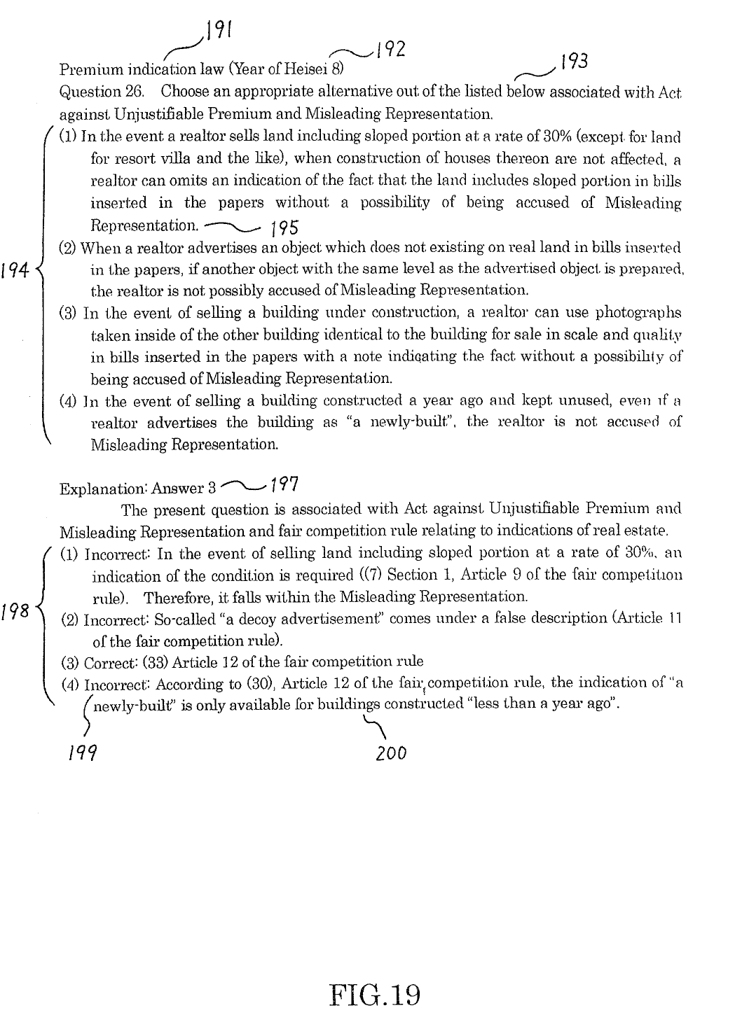

For example, the question reproducible exercise book and the question reproducible system according to the present invention are applicable to all the questions which are answered by choosing an appropriate alternative among a plurality of alternatives and set in examinations held periodically. That is, the above-mentioned question reproducible exercise book and the question reproducible system are applicable to questions answered in the form of choosing an appropriate word to fill in a blank of the question sentence, so-called a fill-in-the-blank question, as shown in FIG. 15 and to a question answered in the form of choosing more than one alternatives in an appropriate combination, as shown in FIG. 16.

According to the present invention claimed in claim 1, learners can omit effort to answer questions and choose alternatives which are set in examinations repeatedly and can utilize time effectively. And tendency of the examination questions can be grasped more accurately by the overlapping questions specifying information.

According to the present invention claimed in claim 2, the learners can easily focus attention with respect to the portions in which the questions and alternatives set in several examinations repeatedly are indicated in a color different from other portions, and the questions and alternatives set in several examinations repeatedly can be hide by the transparent sheet in a color identical to the above-mentioned color, thereby omitting learning the above-mentioned portion for learners' convenience.

According to the present invention claimed in claim 3, the learners can easily omit the questions and alternatives set in several examinations repeatedly and use time effectively. And the tendency of the examination questions can be grasped more accurately by the overlapping questions specifying information.

According to the present invention claimed in claim 4, the learners can easily focus attention on the portions of the questions and alternatives set in several examinations repeatedly by indicating the portions in a color different from other portions.

According to the present invention claimed in claims 5 and 6, the learners can easily indicate only the questions answered incorrectly and the alternatives chosen inappropriately and pay attention to the learners' weak points.

According to the present invention claimed in claim 7, the learners can indicate the questions answered incorrectly and the alternatives chosen inappropriately and further indicate only the questions answered incorrectly again and the alternatives chosen inappropriately again. Therefore, extremely effective learning in order to overcome the learners' weak points becomes possible by repeating above-mentioned procedures.

What is claimed is:

1. A question reproducible exercise book for reproducing questions which are set in examinations held periodically and provided in the form being answered by choosing an appropriate alternative among a plurality of alternatives with respect to the question sentence or a non-relevant in the event of not finding the appropriate alternative,
wherein overlapping questions specifying information including at least numbers of questions and alternatives overlapping in a particular examination and examinations held earlier or later than the particular examination is indicated instead of omitting one or both of a portion of questions and alternatives overlapping in examinations held earlier or later than the particular examination and a portion of explanations with respect to the overlapping questions and alternatives.

2. A question reproducible exercise book for reproducing questions which are set in examinations held periodically and provided in the form of being answered by choosing an appropriate alternative among a plurality of alternatives with respect to the question sentence or a non-relevant in the event of not finding the appropriate alternative,
wherein one or both of a portion of questions and alternatives overlapping in examinations held earlier and later than a particular examination and a portion of explanations with respect to the overlapping questions and alternatives are indicated in a different color form other portions, and a transparent sheet in an identical color to said different color accompanies thereto.

3. A question reproducible system configured to play back a recording medium storing questions which are set in examinations held periodically and provided in the form of being answered by choosing an appropriate alternative among a plurality of alternatives including a non-relevant in the event of not finding an appropriate alternative on a computer and to display the contents on a display screen,
wherein the questions reproduced by year or by category are indicated on said display screen, and when a predetermined point in a menu on the screen is clicked, one or both of a display of overlapping questions and alternatives set in examinations earlier and later than a particular examination and a display of explanations with respect to the overlapping questions and alternatives are erased, and overlapping questions specifying information including at least numbers of questions and the alternatives overlapping in the particular examination and examinations held earlier and later than the particular examination is indicated instead.

4. A question reproducible system configured to play back a recording medium storing questions which are set in examinations held periodically and provided in the form of being answered by choosing an appropriate alternative among a plurality of alternatives including a non-relevant in the event of not finding an appropriate alternative on a computer and to display the contents on a display screen,
wherein the questions reproduced by year or by category are indicated on said display screen, and when a predetermined point in a menu on the screen is clicked, one or both of a portion of questions and alternatives overlapping in the examinations held earlier and later than a particular examination and a portion of explanations with respect to the overlapping questions and alternatives are indicated in a different color from other portions.

5. A question reproducible system configured to play back a recording medium storing examination questions in the form of being answered by choosing an appropriate alternative among a plurality of alternatives including a non-relevant in the event of not finding an appropriate alternative on a computer and to display the contents on a display screen,
in which said examination questions are indicated on said display screen, and when a predetermined point in a menu is clicked after inputting an answer with respect to said question or a choice with respect to said alternatives on the screen, portions of the question and alternatives answered incorrectly among said input answers are indicated in a color different from other portions.

6. A question reproducible system configured to play back a recording medium storing examination questions in the form of being answered by choosing a correct answer among a plurality of alternatives including a non-relevant in the event of not finding an appropriate alternative on a computer and to display the contents on a display screen,
in which said examination questions are indicated on said display screen, and when a predetermined point in a menu is clicked after an answer with respect to said question or a choice with respect to said alternatives is input on the screen, indications of the questions and the alternatives answered correctly are erased and only the questions and alternatives answered incorrectly are indicated.

7. A question reproducible system configured to play back a recording medium storing examination questions in the form of being answered by choosing a correct answer among a plurality of alternatives including a non-relevant in the event of not finding an appropriate alternative on a computer and to display the contents on a display screen,
in which said examination questions are indicated on said display screen, and when a predetermined point in a menu is clicked after an answer with respect to said question or a choice with respect to said alternatives is input on the screen, indications of the questions and the alternatives answered correctly are erased and only the questions and alternatives answered incorrectly are indicated on said screen, and further, when the predetermined point in the menu is clicked after said answers with respect to questions and alternatives answered incorrectly again are input on the screen, only the questions and alternatives answered incorrectly again are indicated and an operation such as mentioned above can be repeated.
